(19) United States
(12) Patent Application Publication
(10) Pub. No.: US 2016/0176424 A1
(43) Pub. Date: Jun. 23, 2016

(54) SYSTEMS AND METHODS FOR REMOTELY CONTROLLING LOCOMOTIVES

(71) Applicant: Electro-Motive Diesel, Inc., LaGrange, IL (US)

(72) Inventors: Gregory Raymond Kupiec, Lemont, IL (US); Paul Peter Jezior, Streamwood, IL (US); Dennis Melas, Chicago, IL (US)

(73) Assignee: Electro-Motive Diesel, Inc., LaGrange, IL (US)

(21) Appl. No.: 14/579,280

(22) Filed: Dec. 22, 2014

(51) Int. Cl. B61L 27/00; B61L 27/04; G05D 1/00

(52) U.S. Cl. CPC B61L 27/0011; B61L 27/0005; G05D 1/0011; B61L 27/04

(57) ABSTRACT

A locomotive system includes a first locomotive having a first locomotive controller configured to control the operation of the first locomotive and a first transceiver and a second locomotive having a second locomotive controller configured to control the operation of the second locomotive and a second transceiver configured to communicate second locomotive operation data to the first transceiver. The system includes a remote control system including a remote transceiver communicatively connected to the first transceiver and a remote controller configured to receive an operation data signal indicative of an operation condition of the second locomotive from the first transceiver. The remote controller is configured to determine an adjustment to a control setting of at least one of the first locomotive controller and the second locomotive controller based on the operation data signal and to send a control signal indicative of the adjustment to the control setting to the first transceiver.

### TECHNICAL FIELD

This disclosure relates generally to control systems and, more specifically, to remote locomotive control systems.

### BACKGROUND

The operation of locomotives, including those that operate in consists with other locomotives, may need to be adjusted based on, for example, operating and environmental conditions. Traditionally, monitoring and adjusting operation was the sole responsibility of the crew at the front of the train or consist. Locomotives within a consist may be in electrical communication with one another, such that operating information regarding other locomotives may be communicated to the lead locomotive, in which the crew operates all locomotives of the consist. For example, the lead locomotive may receive notifications of a fault condition of a trailing locomotive in the consist. Once the crew member in the lead locomotive receives a fault condition notification, he or she must travel to the locomotive experiencing the fault condition to obtain further information regarding the fault. Such systems are inefficient, as the crew members must physically travel to the specific locomotive in the consist to obtain the necessary information to respond to a fault occurrence. The efficiency of the crew to treat fault occurrences then depends on the number of coexisting fault conditions, as well as the number of crew members.

One proposed implementation of locomotive control is described in U.S. Publication No. 2006/0025903 A1 (“the '903 publication”). The '903 publication is directed to a locomotive consist configuration control in which more detailed information is communicated to the lead locomotive regarding fault conditions from other locomotives in the consist. This data may include data from sensor devices on the locomotives as well as information indicating a subsystem failure. The '903 publication also teaches that the operator may receive suggested solutions or other information from a remote database. The system of the '903 publication is designed to allow an operator on the lead locomotive to obtain information to assess a fault condition and to perform the appropriate actions in response to the fault condition without leaving the lead locomotive.

The method and system provided by the '903 publication may be subject to a number of possible drawbacks. For example, the '903 publication does not provide for a locomotive control system that can operate without any input from a crew member on the consist. Additionally, the dependence upon crew to operate and monitor locomotives in the consist requires that each consist contain a sufficient crew to handle all of the fault conditions that may occur.

The presently disclosed systems and methods are directed to overcoming one or more of the problems set forth above and/or other problems in the art.

### SUMMARY

According to one aspect, the present disclosure is directed to a system comprising a first locomotive controller associated with a first locomotive and a plurality of transceivers. The plurality of transceivers may include a first transceiver communicatively connected to the first locomotive controller and a second transceiver in communication with the first transceiver. The system may also include a second locomotive controller associated with a second locomotive. The second locomotive controller may be communicatively connected to the second transceiver. The system may also include a remote control system. The remote control system may be configured to receive an operation data signal from the first transceiver. The operation data signal may be indicative of an operation condition of the second locomotive. The remote control system may be further configured to determine an adjustment to a control setting of at least one of the first locomotive controller and the second locomotive controller based on the operation data signal. The remote control system may also be configured to send a control signal to the first transceiver. The control signal may be indicative of the adjustment to the control setting.

In accordance with another aspect, the present disclosure is directed to a computer-implemented method including receiving, at a remote controller, an operation data signal from a first transceiver associated with first locomotive operation data of a first locomotive and second locomotive operation data associated with a second locomotive. The operation data signal may be received from a first transceiver associated with the first locomotive. The method may also include determining, via the remote controller, an adjustment to a control setting of at least one of a first controller associated with the first locomotive and a second controller associated with the second locomotive based on at least one of the first locomotive operation data and the second locomotive operation data. The method may also include sending, to the first transceiver, via the remote controller, a control signal. The control signal may be indicative of the adjustment to the control setting of the at least one of the first locomotive and the second locomotive. The remote controller may reside in a stationary location separate from the first locomotive and the second locomotive.

According to another aspect, the present disclosure is directed to an autonomous locomotive system. The system may include a first locomotive. The first locomotive may have a first locomotive controller configured to control the operation of the first locomotive and a first transceiver. The system may include a second locomotive. The second locomotive may have a second locomotive controller configured to control the operation of the second locomotive and a second transceiver configured to communicate second locomotive operation data to the first transceiver. The autonomous locomotive system may also include a remote control system. The remote control system may include a remote transceiver communicatively connected to the first transceiver. The remote control system may also include a remote controller. The remote controller may be configured to receive an operation data signal from the first transceiver. The operation data signal may be indicative of an operation condition of the second locomotive. The remote controller may be further configured to determine an adjustment to a control setting of at least one of the first locomotive controller and the second locomotive controller based on the operation data signal. The remote controller may also be configured to send a control signal to the first transceiver. The control signal may be indicative of the adjustment to the control setting.

### BRIEF DESCRIPTION OF THE DRAWINGS

FIG. 1 provides an exemplary embodiment of a consist.

FIG. 2 is a schematic of a remote locomotive control system.

FIG. 3 is flowchart of a process for remotely controlling locomotives.

### DETAILED DESCRIPTION

Reference will now be made in detail to the exemplary embodiments implemented according to the disclosure, the examples of which are illustrated in the accompanying drawings. Wherever possible, the same reference numbers will be used throughout the drawings to refer to the same or like parts.

Embodiments herein include computer-implemented methods, systems, and user interfaces. The computer-implemented methods may be executed, for example, by at least one processor that receives instructions from a non-transitory computer-readable storage medium. Similarly, systems consistent with the present disclosure may include at least one processor and memory, and the memory may be a non-transitory computer-readable storage medium. As used herein, a non-transitory computer-readable storage medium refers to any type of physical memory on which information or data readable by at least one processor may be stored. Examples include random access memory (RAM), read-only memory (ROM), volatile memory, nonvolatile memory, hard drives, CD ROMs, DVDs, flash drives, disks, and any other known physical storage medium. Singular terms, such as “memory” and “computer-readable storage medium,” may additionally refer to multiple structures, such a plurality of memories and/or computer-readable storage mediums. As referred to herein, a “memory” may include any type of computer-readable storage medium unless otherwise specified. A computer-readable storage medium may store instructions for execution by at least one processor, including instructions for causing the processor to perform steps or stages consistent with embodiments herein. Additionally, one or more computer-readable storage mediums may be utilized in implementing a computer-implemented method. The term “computer-readable storage medium” should be understood to include tangible items and exclude carrier waves and transient signals.

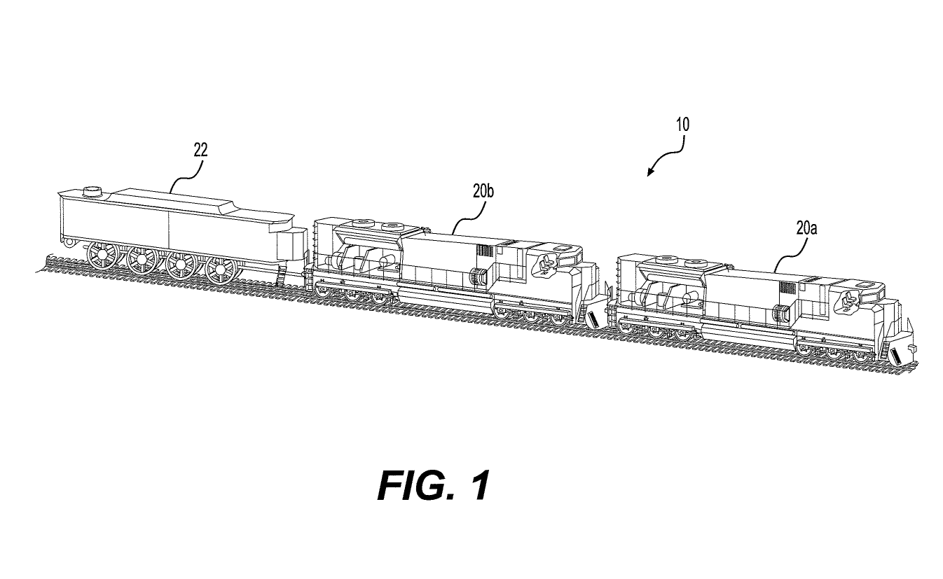

FIG. 1 is a perspective view of an exemplary embodiment of a consist 10 including a plurality of locomotives, such as a first locomotive 20a and a second locomotive 20b. Although not shown in FIG. 1, exemplary consist 10 may include other locomotives in addition to first locomotive 20a and second locomotive 20b. Additionally, consist 10 may also include a variety of other railroad cars, such as, for example, freight cars, tender cars, and/or passenger cars and may employ different arrangements of the cars and locomotives to suit the particular use of consist 10. For example, the exemplary embodiment of consist 10 shown in FIG. 1 includes a tender car 22.

First locomotive 20a and second locomotive 20b may be any electrically powered rail vehicle and may include any number of subsystems for operation (not shown). Such subsystems may include those for traction, braking, exhaust, energy distribution, and cooling. One or more control settings may be associated with at least one of the locomotive subsystems. Such control settings may include powering on/off, adjusting pressure, braking force, speed, or any other feature of locomotive subsystems.

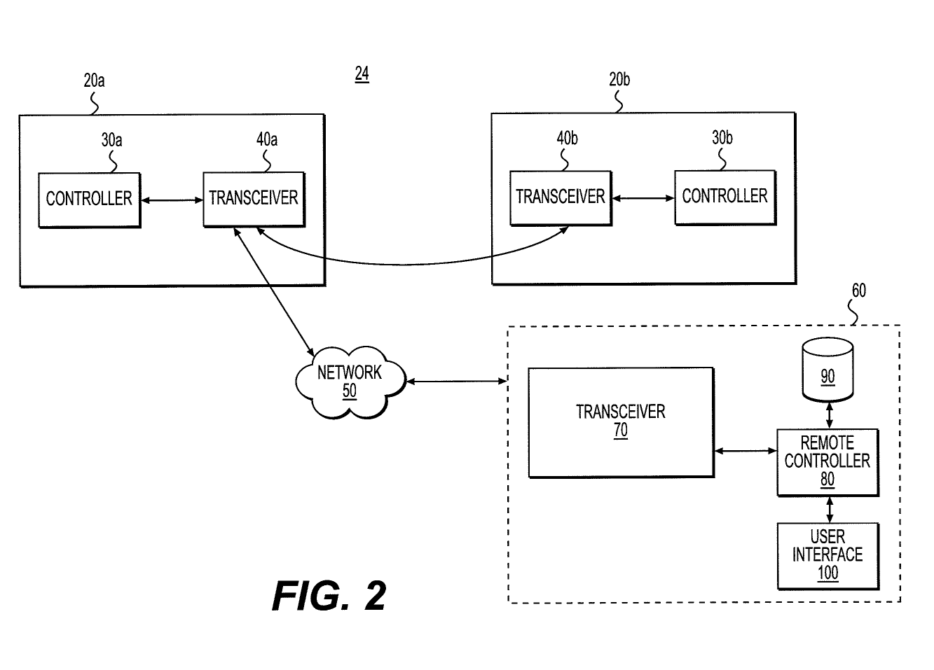

FIG. 2 is a block diagram of an exemplary embodiment of a system 24. System 24 may include first locomotive 20a and second locomotive 20b of consist 10. Additionally or alternatively, system 24 may include locomotives that are physically separate from one another and communicatively connected. System 24 may include one or more server systems, databases, and/or computing systems configured to receive information from entities, such as locomotives, over a network, process and/or store the information, transmit the information to other entities, and display information. In one exemplary embodiment, system 24 may include a first controller 30a and a first transceiver 40a associated with first locomotive 20a. Similarly, system 24 may include a second controller 30b and a second transceiver 40b associated with second locomotive 20b. System 24 may also include a network 50 and a remote control system 60. Remote control system 60 may include a transceiver 70, a remote controller 80, information sources 90, and a user interface 100, as illustrated by a region bounded by a dashed line in FIG. 2.

The various components of system 24 may include an assembly of hardware, software, and/or firmware, including a memory, a controller, a central processing unit (CPU), and/or a user interface. Memory may include any type of RAM or ROM embodied in a physical storage medium, such as magnetic storage including floppy disk, hard disk, or magnetic tape; semiconductor storage such as solid state disk (SSD) or flash memory; optical disc storage; or magneto-optical disc storage. A CPU or controller may include one or more processors for processing data according to a set of programmable instructions or software stored in the memory. The functions of each processor may be provided by a single dedicated processor or by a plurality of processors. Moreover, processors may include, without limitation, digital signal processor (DSP) hardware, or any other hardware capable of executing software. An optional user interface may include any type or combination of input/output devices, such as a display monitor, keyboard, and/or mouse.

As described above, remote control system 60 may be configured to receive data over network 50, process and analyze the data, and control first locomotive 20a and/or second locomotive 20b based on the processed data. For example, system 60 may receive operating data from first controller 30a, second controller 30b, information sources 90, user interface 100, and/or other entities on network 50.

It will be appreciated that any suitable configuration of software, processors, and data storage devices may be selected to implement the components of system 24 and features of related embodiments. The software and hardware associated with system 24 may be selected to enable quick response to fault occurrences or operating conditions of first locomotive 20a and/or second locomotive 20b. An emphasis may be placed on achieving high performance through scaling on a distributed architecture. The selected software and hardware may be flexible to allow for quick reconfiguration, repurposing, and prototyping for research purposes. The data flows and processes described herein are merely exemplary, and may be reconfigured, merged, compartmentalized, and combined as desired. The exemplary modular architecture described herein may be desirable for performing data intensive analysis. A modular architecture may also be desired to enable efficient integration with external platforms, such as content analysis systems, various plug-ins and services, etc. Finally, the exemplary hardware and modular architecture may be provided with various system monitoring, reporting, and troubleshooting tools.

In accordance with certain embodiments, the components of system 24 may perform various methods for autonomously and remotely controlling first locomotive 20a and second locomotive 20b. For example, remote control system 60 may receive data from first locomotive 20a and second locomotive 20b and control operation of first locomotive 20a and/or second locomotive 20b without the need for onboard operator input.

As shown in FIG. 2, first locomotive 20a may include first controller 30a for managing the operation of first locomotive 20a. Likewise, second locomotive 20b may include second controller 30b for managing the operation of second locomotive 20b. First controller 30a and second controller 30b control various subsystems of first locomotive 20a and second locomotive 20b, respectively.

First controller 30a may further receive information from subsystems of first locomotive 20a indicative of the operation and/or status of the subsystems. For example, first controller 30a may receive operation data from sensors associated with the subsystems. First controller 30a may be configured to analyze operation data and identify a fault occurrence. Additionally or alternatively, first controller 30a may receive fault occurrence notifications from the subsystems of locomotive 20a. Additionally, first controller 30a may be configured to receive operational information and/or fault occurrence notifications from second controller 30b and relay at least a portion of that information to remote control system 60. First controller 30a may be configured to transmit signals indicative of operating conditions or a fault occurrence of first locomotive 20a and/or second locomotive 20b to remote control system 60 and receive control signals indicative of an adjustment to the operation of first locomotive 20a and/or second locomotive 20b.

Similarly, for second locomotive 20b, second controller 30b may further receive information from subsystems of second locomotive 20b indicative of the operation and/or status of the subsystems. For example, second controller 30b may receive operation data from sensors associated with the subsystems. Second controller 30b may be configured to analyze operation data and identify a fault occurrence. Additionally or alternatively, second controller 30b may receive fault occurrence notifications from locomotive 20b. Second controller 30b may be configured to communicate fault occurrence notifications and/or operation data related to second locomotive 20b to first controller 30a via first and second transceivers 40a and 40b.

First controller 30a may be communicatively connected to first transceiver 40a. First transceiver 40a may be any combination of hardware and/or software that enables the receipt and transmission of signals between first locomotive 20a and second locomotive 20b. For example, a multiple-unit train control (MU) line may be used to share information between first locomotive 20a and second locomotive 20b. For example, first transceiver 40a may receive operation data and fault occurrence notifications associated with second locomotive 20b from second controller 30b. Additionally or alternatively, first transceiver 40a may communicate control signals for second locomotive 20b to second controller 30b. First transceiver 40a may further be capable of wirelessly transmitting and receiving signals through network 50. For example, first transceiver 40a may be employ a combination of cellular, satellite, and/or Wi-Fi technologies to communicate via network 50. In particular, first transceiver 40a may be configured to communicate with remote control system 60.

Second controller 30b may be communicatively connected to second transceiver 40b. Second transceiver 40b may be any combination of hardware and/or software that enables the receipt and transmission of signals between second locomotive 20b and first locomotive 20a. For example, an MU line may be used to share information between second locomotive 20b and second locomotive 20b. For example, second transceiver 40b may transmit operation data and fault occurrence notifications associated with second locomotive 20b from second controller 30b to first transceiver 40a. Additionally or alternatively, second transceiver 40b may receive control signals from first transceiver 40a. Second controller 30b need not include capability to communicate wirelessly through network 50, but it may include this optional functionality.

While first transceiver 40a communicates to remote control system 60 through network 50, second locomotive 20b communicates the operation data and fault occurrence notifications to first controller 30a of first locomotive 20a, which in turn relays that information to remote control system 60. In this manner, remote control system 60 need not communicate directly with each locomotive of consist 10. For example, according to some embodiments, remote control system 60 communicates with first transceiver 40a and receives communications from second locomotive 20b via first transceiver 40a.

As explained above, remote control system 60 receives information regarding the operation of first locomotive 20a and second locomotive 20b, analyzes this information, and controls the operation of first locomotive 20a and/or second locomotive 20b. According to some embodiments, the remote control system may control first locomotive 20a and second locomotive 20b autonomously. Remote control system 60 may be a station located near railways. For example, remote control system 60 may include wayside equipment that is physically separate from first locomotive 20a and second locomotive 20b. Alternatively, remote control system 60 may be mobile such that it may travel separately from first locomotive 20a and second locomotive 20b.

As first locomotive 20a and second locomotive 20b travel along the railway, it may be desirable for different remote control systems 60 to become responsible for monitoring and controlling first locomotive 20a and second locomotive 20b. For example, as consist 10 comes within the range of a second remote control system, remote control system 60 may pass control to that second remote control system.

As shown in FIG. 2, remote control system 60 may include transceiver 70. Transceiver 70 may be any combination of hardware and/or software that enables the receipt and transmission of signals between first locomotive 20a remote controller 80 through network 50. For example, transceiver 70 may receive signals indicative of operation data of first locomotive 20a and/or second locomotive 20b. Similarly, transceiver 70 may be configured to receive signals indicative of a fault occurrence on first locomotive 20a and/or second locomotive 20b. According to some embodiments, first transceiver 40a may be employ a combination of cellular, satellite, and/or Wi-Fi technologies to communicate via network 50. In this manner, transceiver 70 may facilitate communications between remote controller 80 of remote control system 60 and other electronics through network 50.

Remote control system 60 may communicate with only one of first transceiver 40a and second transceiver 40b. For example, according to some embodiments, second transceiver 40b may communicate operation data to first transceiver 40a to be relayed to remote control system 60. In this manner, communications from other transceivers to remote control system 60 are performed via first transceiver 40a.

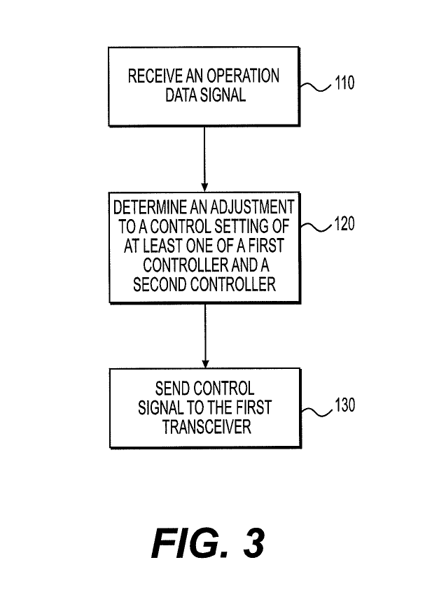

FIG. 3 is a flowchart of an exemplary method by which remote controller 80 receives data from a number of sources and uses this data to remotely control first locomotive 20a and second locomotive 20b.

At step 110, remote controller 80 may receive an operation data signal from first transceiver 40a. The operation data signal may be indicative of operation data of first locomotive 20a. Additionally or alternatively, the operation data signal may be indicative of operation data of second locomotive 20b. Such data may be sent by first controller 30a via first transceiver 40a. Such data may include raw or preprocessed data regarding the operation of first locomotive 20a received by first controller 30a from subsystems of first locomotive 20a. Additionally or alternatively, operation data may include warnings, alarms, or notifications of a fault condition or occurrence of first locomotive 20a. Likewise, second locomotive operation data may include raw or preprocessed data regarding the operation of second locomotive 20b and/or warnings, alarms, or notifications of a fault condition or occurrence of second locomotive 20b.

At step 120, remote controller 80 may determine an adjustment to a control setting of at least one of first controller 30a and second controller 30b based on the operation data of at least one of first locomotive 20a and second locomotive 20b. For example, remote controller 80 may determine a fault condition of locomotive 20a based on an analysis of the operation data. Remote controller 80 may determine an adjustment to the control settings of first controller 30 to respond to the fault condition. Additionally or alternatively, remote controller 80 may determine an adjustment to control settings of first controller 30a based on a variety of different factors. For example, adjustments may be identified based on one or more of first locomotive operation data, second locomotive operation data, preprogrammed responses obtained by remote controller 80 via information sources 90, and/or an input received via user interface 100 from an operator working at remote control system 60. Once an adjustment is identified, remote controller 80 may remotely control the operation of first locomotive 20a and/or second locomotive 20b.

At step 130, remote controller 80 may send a control signal to first transceiver 40a. The control signal may be indicative of the adjustment to the control setting identified in step 120. In this manner, remote controller 80 may operate first locomotive 20a and second locomotive 20b without requiring input from an onboard operator at first controller 30a and/or second controller 30b.

In some circumstances, it may be desirable for the control of remote control system 60 to be overridden by first locomotive 20a and/or second locomotive 20b. Thus, remote controller 80 may receive an override signal via first transceiver 40a in response to the control signal. Such override signals may include a command to reject the adjustment of the control signal. The override signal may optionally an alternative adjustment to be made to one or more control settings of first controller 30a and/or second controller 30b. Remote controller 80 may acknowledge the override signal by sending a second control signal to first transceiver 40a. The second control signal may be indicative of the alternative adjustment to the control setting of the at least one of the first locomotive and the second locomotive.

### INDUSTRIAL APPLICABILITY

The disclosed systems and methods provide a robust solution for remote locomotive control. For example, the presently described systems and methods do not require input from any onboard operators to adjust the control settings of locomotives. These adjustments can be performed autonomously and/or by a remote operator at a remote control station.

The presently disclosed systems and methods may have several advantages over other attempted solutions. For example, the disclosed systems and methods allow consists or locomotives to be operated by fewer onboard operators, as some of the responsibility may be handled by remote operators. Further, remote control stations may be better equipped to maintain the most up-to-date solutions for particular fault occurrences, as remote operators may be specialized in particular technical areas. Additionally, it may be more economical to maintain more recent software and more powerful controllers to process and analyze the data at remote control stations than to maintain such systems on each individual locomotive.

It will be apparent to those skilled in the art that various modifications and variations can be made to remote locomotive control systems and associated methods for operating the same. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A system comprising:
a first locomotive controller associated with a first locomotive;
a plurality of transceivers including a first transceiver communicatively connected to the first locomotive controller and a second transceiver in communication with the first transceiver;
a second locomotive controller associated with a second locomotive, the second locomotive controller communicatively connected to the second transceiver; and
a remote control system configured to:
receive an operation data signal from the first transceiver, the operation data signal indicative of an operating condition of the second locomotive;
determine an adjustment to a control setting of at least one of the first locomotive controller and the second locomotive controller based on the operation data signal; and
send a control signal to the first transceiver, the control signal indicative of the adjustment to the control setting.

2. The system of claim 1, wherein the remote control system is configured to directly communicate with only one of the plurality of transceivers, such that communications from other transceivers of the plurality of transceivers to the remote control system are performed via the first transceiver.

3. The system of claim 1, wherein the first transceiver communicates with the remote control system wirelessly and the first transceiver communicates with the second transceiver using an MU line.

4. The system of claim 1, wherein the first locomotive and the second locomotive are communicatively connected to and physically separate from one another.

5. The system of claim 1, wherein the remote control system is wayside equipment that is physically separate from the first locomotive and from the second locomotive.

6. The system of claim 5, wherein an operator of the remote control station operates the first and second locomotives using a user interface at the remote control system.

7. The system of claim 6, wherein the remote control system is further configured to determine the adjustment to the operating condition based on a user input received via the user interface.

8. The system of claim 6, wherein the remote control system is configured to pass control of at least one of the first locomotive and the second locomotive to a second remote control system.

9. An autonomous locomotive system comprising:
a first locomotive including a first locomotive controller configured to control the operation of the first locomotive and a first transceiver;
a second locomotive including a second locomotive controller configured to control the operation of the second locomotive and a second transceiver configured to communicate second locomotive operation data to the first transceiver; and
a remote control system including:
a remote transceiver communicatively connected to the first transceiver; and
a remote controller configured to:
receive an operation data signal from the first transceiver via the remote transceiver, the operation data signal indicative of an operating condition of the second locomotive;
determine an adjustment to a control setting of at least one of the first locomotive controller and the second locomotive controller based on the operation data signal; and
send a control signal to the first transceiver, the control signal indicative of the adjustment to the control setting.

10. The autonomous locomotive system of claim 9, wherein the remote control system is wayside equipment that is physically separate from the first locomotive and from the second locomotive.

11. The autonomous locomotive system of claim 9, wherein the remote control system further includes a user interface.

12. The autonomous locomotive system of claim 11, wherein an operator of the remote control system remotely operates the first and second locomotives via the user interface.

13. The autonomous locomotive system of claim 9, wherein the remote control system may pass control of at least one of the first locomotive and the second locomotive to a second remote control system.

14. The autonomous locomotive system of claim 9, wherein the remote control system is configured to directly communicate with only one of the plurality of transceivers, such that communications from other transceivers of the plurality of transceivers to the remote control system are performed via the first transceiver.

15. The autonomous locomotive system of claim 9, wherein first locomotive and second locomotive are communicatively connected to and physically separate from one another.

16. A computer-implemented method comprising:
receiving, at a remote controller, an operation data signal indicative of first locomotive operation data associated with a first locomotive and second locomotive operation data associated with a second locomotive from a first transceiver associated with the first locomotive;
determining, via the remote controller, an adjustment to a control setting of at least one of a first controller associated with the first locomotive and a second controller associated with the second locomotive based on at least one of the first locomotive operation data and the second locomotive operation data; and
sending, to the first transceiver, via the remote controller, a control signal indicative of the adjustment to the control setting of the at least one of the first locomotive and the second locomotive, wherein the remote controller resides in a stationary location separate from the first locomotive and the second locomotive.

17. The method of 16, wherein the remote controller is wayside equipment that is physically separate from the first locomotive and from the second locomotive

18. The method of 16, wherein determining, via the remote controller, an adjustment to a control setting of at least one of a first controller associated with the first locomotive and a second controller associated with the second locomotive based on at least one of the first locomotive operation data and the second locomotive operation data further includes determining the adjustment based on a user input received at the remote controller via a user interface.

19. The method of claim 16, further including receiving an override signal via the first transceiver, the override signal including a command to reject the adjustment of the control signal and an alternative adjustment.

20. The method of claim 19, further including, in response to receiving the override signal, sending a second control signal via the first transceiver, the second control signal indicative of the alternative adjustment to the control setting of the at least one of the first locomotive and the second locomotive.
